(19) United States
(12) Patent Application Publication
(10) Pub. No.: US 2020/0003285 A1
(43) Pub. Date: Jan. 2, 2020

(54) GUIDANCE DEVICE WITH FLEXIBLE HIGH FATIGUE RESISTANCE PSEUDO-PARALLELOGRAMS

(71) Applicant: COMMISSARIAT A L'ENERGIE ATOMIQUE ET AUX ENERGIES ALTERNATIVES, PARIS (FR)

(72) Inventors: Maxime BECK, Paris (FR); Mathieu GROSSARD, VERRIERES LE BUISSON (FR)

(21) Appl. No.: 16/484,036

(22) PCT Filed: Feb. 19, 2018
(86) PCT No.: PCT/EP2018/054021

§ 371 Date: Aug. 6, 2019

(30) Foreign Application Priority Data
Mar. 7, 2017 (FR) 1751841

(51) Int. Cl. F16H 21/04; F16H 25/20

(52) U.S. Cl. CPC F16H 21/04; F16H 2025/204; F16H 25/20

(57) ABSTRACT

The device able to guide a member in translational movement, includes two pairs of flexible beams which are symmetric about an axis, the two beams of one pair being curved and not mutually parallel; a central mechanical structure through which the axis passes and to which the pairs of beams are attached at fixing points, the mechanical structure being able to be mechanically connected to the member; two mechanical interfaces to each of which a pair of beams is attached at fixing points, the interfaces being able to be attached to a mechanical structure; the two sets of attachment points situated on either side of the axis of symmetry each forming a parallelogram, the guidance of the member being obtained by means of a force exerted on the central mechanical structure parallel to the axis of symmetry.

The present invention relates to a guidance device having high fatigue-strength flexible pseudo parallelograms. It notably applies to the guidance of members that require precise and pure-translational movements.

It is known that polyarticulated systems of the parallelogram type provide guided movements. It is also known practice to replace these with parallelogram systems having flexible beams, either single or double parallelogram. These systems notably exhibit a serious disadvantage which is their poor ability to withstand stressing. Specifically, guidance is notably assured by the bending of the beams, leading to mechanical stresses, particularly, but not only, at the anchor points of these beams. In operation, these guidance systems are thus constantly subjected to stressing causing breakages in time frames that can be relatively short depending on the application. As a general rule, these systems do not have high fatigue strength and therefore have a limited life.

It is an object of the invention notably to increase the fatigue strength of these parallelogram guidance systems, and therefore to significantly increase the life thereof.

To this end, the subject of the invention is a guidance device able to guide a member in translational movement, comprising at least:

two pairs of flexible beams which are symmetric about an axis, the two beams of one pair being curved and not mutually parallel;

a central mechanical structure through which said axis passes and to which said pairs of beams are attached at fixing points B, C, A′, D′, said mechanical structure being able to be mechanically connected to said member;
two mechanical interfaces to each of which a pair of beams is attached at fixing points A, B, C′, D′, said interfaces being able to be attached to a mechanical structure;
   the two sets of attachment points A, B, C, D, A′, B′, C′, D′ situated on either side of said axis of symmetry each forming a parallelogram, the guidance of said member being obtained by means of a force exerted on said central mechanical structure parallel to said axis of symmetry.

In one possible embodiment, said beams comprise several rectilinear sections, the sections leading from the ends of said beams being parallel.

Said beams have, for example, non-constant cross sections, the cross section being, for example, at a minimum at the center and/or at a maximum at the level of the points of attachment of said beams.

Said device is, for example, of monolithic structure.

Said mechanical structure is, for example, mobile.

Said central mechanical structure has, for example, passing through it, a nut which is rigidly connected to it, said member being a screw collaborating with said nut.

Further features and advantages of the invention will become apparent from the following description given with reference to the attached drawings which depict:

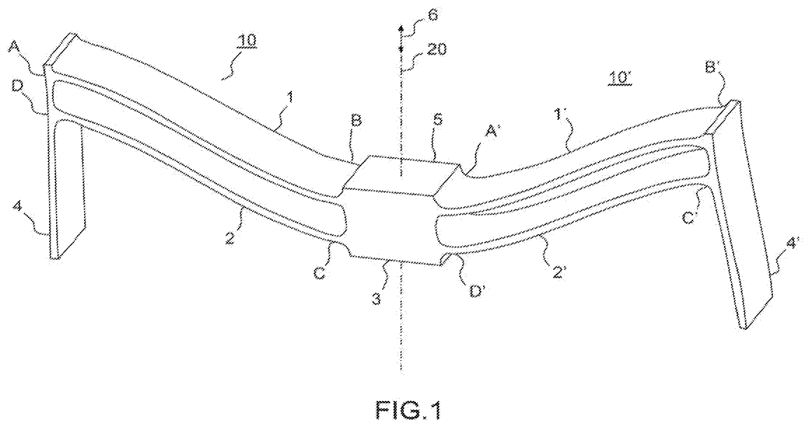

FIG. 1: a double parallelogram guidance system;

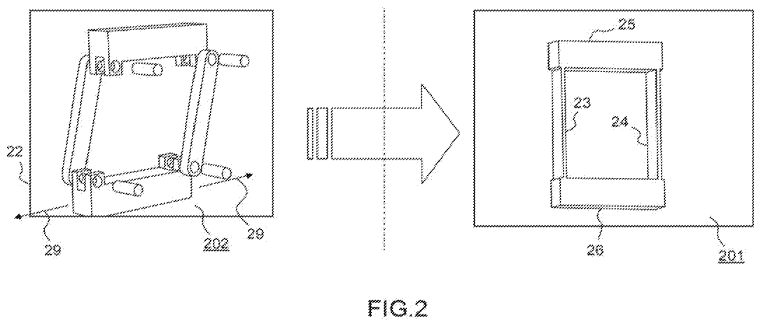

FIG. 2: a parallelogram-type structure used in the above system;

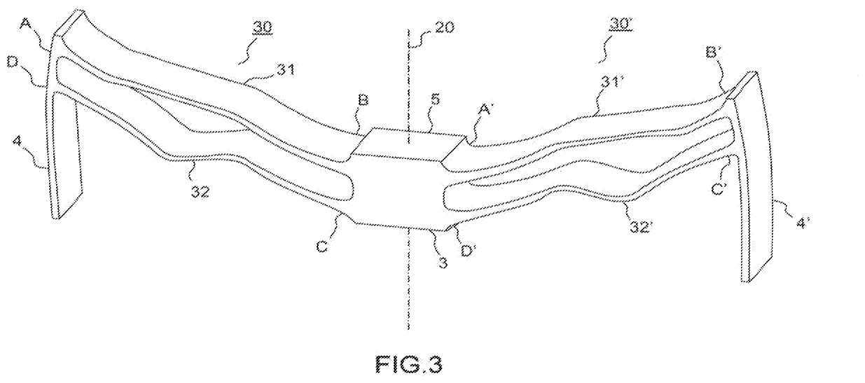

FIG. 3: one exemplary embodiment of a guidance device according to the invention, viewed in perspective, having high fatigue strength;

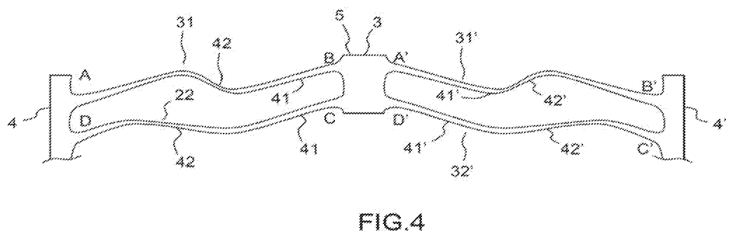

FIG. 4: the device of FIG. 3, viewed in cross section;

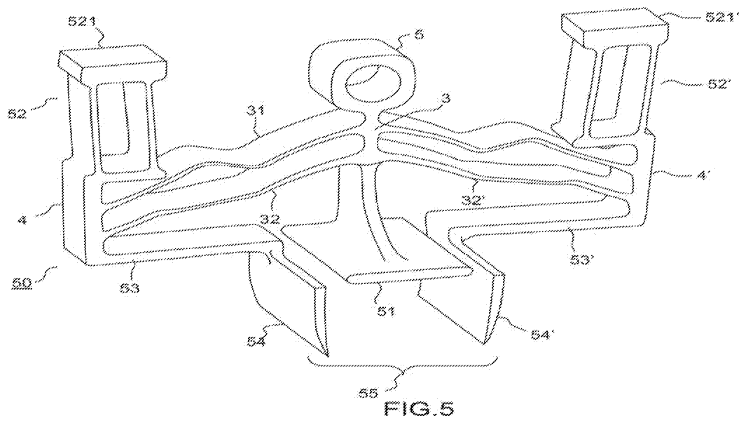

FIG. 5: one exemplary embodiment of a gripper system incorporating a guidance device according to the invention;

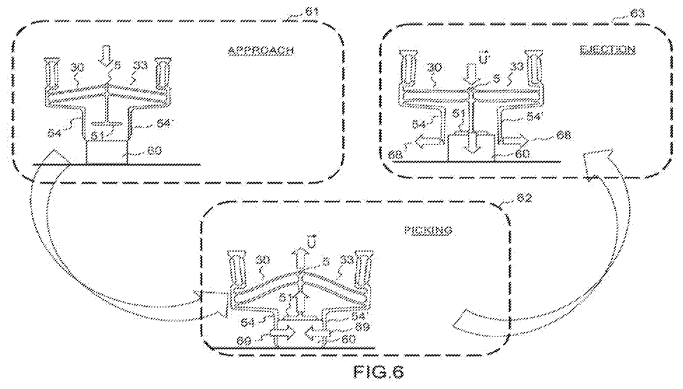

FIG. 6: a pick and place cycle using the above system;

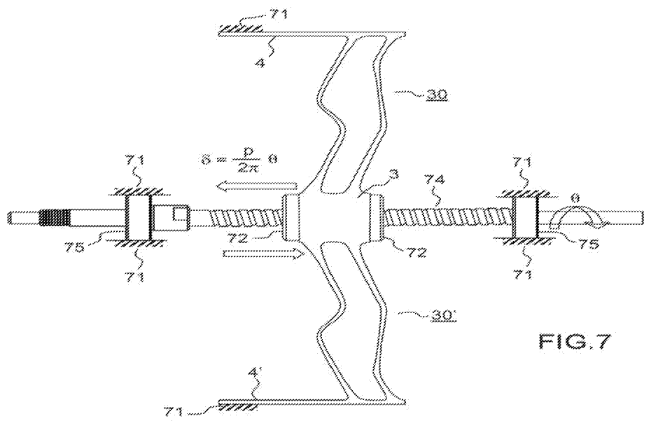

FIG. 7: a screw-type actuating device equipped with an anti-rotation system produced by a device according to the invention.

FIG. 1 shows a double parallelogram guidance system. It is made up of a first parallelogram 10 and of a second parallelogram 10′, both deformable, connected by a central structure 3. Each parallelogram comprises two parallel flexible beams 1, 2, 1′, 2′ forming two, flexible, first sides. The other two sides of the parallelogram are rigid and formed on the one hand of a wall of the central structure 3 and, on the other hand, of all or part of the mechanical interface 4, 4′.

The central structure 3 is able to interface with a member that is to be guided, being rigidly connected thereto for example. The interfaces 4, 4′ are able to be attached to a fixed or mobile mechanical structure.

FIG. 2 shows a monolithic parallelogram structure 201 of the type of those 10, 10′ used in the double parallelogram system of FIG. 1. This parallelogram structure is made up of two opposite rigid sides 25, 26 connected by two parallel flexible beams 23, 24. These beams act like a flexible guidance system by bending at their attachment points, while at the same time remaining stiff in terms of tension. This flexible beams parallelogram structure is able to replace the guidance 29 obtained by a polyarticulated parallelogram structure 202 with rotation pivots.

The beams 23, 24, which are flexible in bending and stiff in tension, make it possible to obtain guidance in pure rectilinear, which is to say accurate, movements parallel to the other two sides 25, 26 of the parallelogram to which sides the beams are attached.

A double parallelogram system of the type of FIG. 1 therefore makes it possible to guide with precision a member connected to the central structure 3 whereas the interfaces 4, 4′ are fixed to a structure, guidance being achieved with respect to that structure. In other words, pure or near-pure translational movement is obtained.

The input point 5 of the system is mechanically secured to the central structure. It is at this point 5 that a movement is imposed. More specifically, the translational movement is obtained by a force exerted on the central mechanical structure 3 parallel to said axis of symmetry. In practice, the guidance of a member mechanically connected to this central structure 3 is achieved by actuating this member, this actuation exerting a force on the central structure 3. Examples of guidances will be described later on.

In this mechanism, which is symmetric about the guide axis 20, the anchor points A, B, C, D, A′, B′, C′, D′ at which the beams are anchored to the interfaces 4, 4′ and to the central structure 3 are subjected to stress concentrations which may greatly reduce the life of the mechanism because of the breakages liable to occur at these anchor points.

FIG. 3 shows an exemplary embodiment of a guidance device according to the invention. This device no longer comprises two parallelograms as in the case of FIG. 1, but two pseudo parallelograms 30, 30′ inasmuch as the flexible beams 31, 32, 31′, 32′ that form two first sides of each pseudo parallelogram 30, 30′ are no longer rectilinear and parallel. Nevertheless, the ends A, B, C, D, A′, B′, C′, D′ of each pseudo parallelogram still form a parallelogram.

The flexible beams are still connected on the one hand to the central structure 3 and on the other hand to the interface 4, 4′ by the anchor points that form the ends A, B, C, D, A′, B′, C′, D′ of the parallelograms. They are curved and not parallel as illustrated in FIG. 3. Each beam for example comprises several rectilinear sections having different orientations. The sections leading from the central structure or from the interfaces are, for example, parallel.

Guidance of a member is obtained according to the same principle as was described in relation to FIG. 1. However, in a device according to the invention according to the example of FIG. 3, the maximum stresses are reduced.

Specifically, if the stress distribution within a mechanism having parallel and straight beams is studied, it may be seen that this stress distribution is not the same between the two opposing beams of the one same parallelogram. In the rest position, the beams are truly straight and truly parallel. By contrast, under load, when a movement is imposed at the input 5, the curvature of the beams is not the same and the parallelism is no longer satisfied. The stresses are therefore no longer the same because simultaneous tension loadings make their appearance. Thus, in order to prevent one beam from being more heavily loaded than the other and in order to prevent the distribution from one to the other from not being uniform, according to the invention a double beams (pseudo parallelogram as described hereinabove) system is created in which the beams are no longer parallel, the anchor points A, B, C, D, A′, B′, C′, D′, which are the ends of the pseudo parallelogram, still forming a parallelogram.

In guidance, the path of a member guided by the device can still be likened to a pure translational movement along the axis of symmetry 20. The flexibility of the beams in the dimension parallel to this axis, coupled with the stiffness of the beams in the perpendicular direction (across the width of the beams) makes it possible to obtain such a translational movement, the stiffness component blocking unwanted rotational movements.

With the beam lengths being, for example, of the order of 40 mm, the translational movement 6 may then be of the order of 10 mm.

A device according to the invention may also comprise beams 31, 32, 31′, 32′ of non-constant cross section, as illustrated also in FIG. 3. Reference is made to FIG. 4 which shows a view in cross section, to describe a device with variable cross sections.

FIG. 4, like FIG. 3, shows an exemplary embodiment with beams of variable cross section, improving the uniformity of the mechanical stresses across the beams.

When loaded, which means to say when a movement is imposed at the input 5 of the mechanism, the beams 31, 32, 31′, 32′ are subjected to a stress gradient. Thus, certain points of the curve formed by a beam (which can be parameterized as a curvilinear abscissa), are the sites of higher stresses or, rather, of near-zero stresses (these sites are referred to as neutral points). Overall, the neutral points 42, 42′ are positioned substantially mid-way along the length of the beams and the stress concentrations are at the anchor points.

The objective of the optimization using variable cross sections is to obtain uniform stress within each beam. The thicknesses are altered locally in order to make the stresses uniform.

In the exemplary embodiment of FIG. 4, variable cross sections are introduced into the flexible beams. By locally increasing their thickness, the stress is locally reduced. The thickness is increased at the points 41, 41′, and in particular, the cross section is at a maximum at the anchor points A, B, C, D, A′, B′, C′, D′ at which the beams are anchored to the rigid parts 3, 4, 4′ and then decreases toward the center of the beams, at the neutral points 42, 42′.

Conversely, by removing material at these points 42, 42′ of minimum stress, the internal stresses can be locally increased.

The variable cross section notably has the effect of making the stress gradient more uniform and therefore of reducing the stress concentrations within one same beam. By eliminating the points at which these stresses are concentrated, the life of the device according to the invention is increased.

It is impossible for this uniformity to be perfect because it would be necessary to tend toward a zero beam thickness at the points 42, 42′ of zero stress. However, the non-constant distribution of the volume or density of material along the longitudinal axis of the beams, as illustrated in FIGS. 3 and 4, makes it possible to distribute and even out the stresses as well as possible over the entire length of the beams and therefore further increase the life thereof.

FIG. 5 shows a first example of a use of a guidance device according to the invention. In this example, this device is incorporated into a gripper clamp 50 and has the notable function of ensuring the translational movement of a push plate 51. The latter is mechanically secured to the central structure 3. The mechanical interfaces 4, 4′ are each connected to a flexible parallelogram 52, 52′, itself able to be connected by one of its sides 321, 321′ to a mechanical structure, for example one that is fixed. The interfaces 4, 4′ are moreover each connected to a jaw 54, 54′ of a gripper clamp 55, via an arm 53, 53′. The assembly is activated by the input point 5, embodied by a loop.

A gripper device illustrated in FIG. 5 may advantageously be used for picking up fragile objects, comprising pick and place phases.

FIG. 6 illustrates a cycle for the picking and placing of a flexible object 60 using a device according to FIG. 5. For the sake of ease of depiction, the beams of the pseudo parallelograms 30, 30′ have been depicted as rectilinear and parallel.

This cycle comprises an approach phase 61, a phase 62 of picking the object and a phase 63 of ejecting the object.

In the approach phase 61, the plate 51 is not in contact with the object and the jaws are in the open position. The structure to which the gripper device is attached is, for example, a robot arm the movement of which is guided toward the object, causing the device to be guided toward the object. At the end of the approach phase, the jaws come level with the object and the plate 51 is kissing the object.

In the picking phase 42 an activation force U is exerted on the activation point or input point 5, in the direction away from the jaws 54, 54′, causing the object to be clamped 69 by the jaws, acting as a gripper clamp, and causing the plate 51 to be guided upward.

In the ejection phase, an opposing activation force U′ is exerted on the activation point 5, in the direction of the jaws, causing the jaws to open and therefore causing the object to be unclamped 68 and the plate 51 to be guided downward until it lies between the jaws, the plate then acting as a pusher to push the object.

In practice, the movement of the activation point 5 in one direction or the other may be less than one centimeter, for example of the order of 7 mm.

The gripper device is underactuated, which means to say that it has more degrees of freedom that it does actuators. Specifically, one single actuation point 5 makes it possible to obtain, in a phase 62, the controlled clamping of the jaws around the object 60 and then, in a subsequent phase 463, guaranteed placement by pure translational movement of the push plate 51 toward the object. The pure translational movement of the plate 51 perpendicular to the opening path of the jaws 54, 54′ makes it possible to prevent the object from sticking to the jaws and makes it possible to correct final positioning errors during placement. This placement can be performed with precise positioning of the object in a container for example.

FIG. 7 illustrates another example of a use of a guidance device according to the invention. This device may advantageously be used in applications in which rectilinear movements with large travels and long life are required, very well suited to the application example of FIG. 7.

Reference is made for example to the cable actuator system described in French patent application FR 3 004 230 A1, more particularly in FIG. 1 of that document. In the mechanism described, the screw is rotationally driven by an electric motor. A nut collaborates with the screw and is associated with an anti-rotation device comprising two arms and a roller, the two arms extending on either side of the nut to bear rollers engaged in longitudinal slots in order to block rotational movements.

In this anti-rotation function, the nut in question has to be prevented from rotating in order to accomplish a rectilinear straight-line outbound and return movement along the axis of the screw and thus transmit a force, for example via cables anchored to articulated-joint pulleys. The mechanism of FIG. 7 allows this objective to be achieved.

In this setup, the device according to the invention is rigidly connected, via its mechanical interfaces 4, 4′ (at the interface bases in order to allow the beams to flex because a tensile load is residual) to a fixed support 71, for example the chassis referenced 1 in FIG. 1 of document FR 3 004 230 A1. The central structure 3 also has, passing through it, a nut 72 which is rigidly connected thereto. This nut 72 collaborates with a screw 74, of the type for example of the screw 2 of the abovementioned document. This screw 74 is held on the fixed structure 71, for example the chassis 1 of the abovementioned document, via two supports 75 in which the shank extending the screw slides. It is rotationally driven by a motor, not depicted. A rotation of the screw through an angle θ causes a movement δ such that

$$δ = \frac{P}{2 π} θ .$$

By virtue of the device according to the invention, which acts as an anti-rotation system in this application, the nut 72 is in an isostatic arrangement, making it possible to avoid internal stresses, and hence promote its transparency and thus the user feedback felt.

In this application, there is a rest position, corresponding to the energy minimum, and a return to this position by a return force, it being possible for the flexible device according to the invention to be likened to a spring of constant and known stiffness K.

In the system described in FIG. 1 of the aforementioned document, the anti-rotation function is achieved via rollers (rolling bearings) which roll along longitudinal slots. There is therefore some operational clearance between a roller and the contact surface actually within the rolling bearing, and this is a cause of imprecision particularly on a change in direction of translational movement (change of direction in rotation θ). The friction in the rolling of the roller contributes to increasing the static friction threshold, the dry friction and the viscous friction of the actuator in general. It is very difficult to fully anticipate and to incorporate this friction into the control laws. In addition, the low mass and inertia of the screw device also contributes to increasing the transparency of the transmission.

The monolithic nature of the structure of the device according to the invention simplifies assembly by minimizing the number of components.

The improvement in the transparency encourages the reversibility of the actuation, allowing more faithful return and force control by direct measurement of motor current. The constant and known flexibility of the device according to the invention can be taken into account in the model of the actuator and makes it possible to work back to the external forces applied to the actuator. The presence of a load sensor becomes unnecessary.

By combining this flexible anti-rotation system (achieved using the device according to the invention) with an actuator, movement and control are more precise because of the absence of clearance and friction (the movement is a pure translational movement), simpler, more compact, more lightweight and therefore having lower inertia. The handling operation is easier for the user, for whom the feedback felt is very important in collaborative robotics or remote operation.

Other guidance applications using a device according to the invention are of course possible. Such a device advantageously allows pure translational movements, with large travels in bending of the pseudo parallelogram, while at the same time exhibiting good fatigue strength.

Advantageously, the device according to the invention is monolithic, manufactured from the one same material. The material used may be a polymer of the type polyoxymethylene, POM homopolymer or copolymer of acetal, polyetheretherketone also known by the name PEEK, polyamide or polyimide. There is no play and no friction, guaranteeing movement precision.

Inexpensive and robust, low in mass, a device according to the invention can be manufactured easily by molten polymer deposition, or by laser cutting, or even by numerically controlled cutting. All the components of the device and notably the beams can be machined from one single block of material.

A device according to the invention is a flexible monolithic system equivalent to a polyarticulated kinematic system which does not require assembly, avoids the phenomena of fouling, and facilitates cleaning and manufacture.

1. A guidance device able to guide a member in translational movement, wherein it comprises:
two pairs of flexible beams which are symmetric about an axis, the two beams of one pair being curved and not mutually parallel;
a central mechanical structure through which said axis passes and to which said pairs of beams are attached at fixing points, said mechanical structure being able to be mechanically connected to said member;
two mechanical interfaces to each of which a pair of beams is attached at fixing points, said interfaces being able to be attached to a mechanical structure;
the two sets of attachment points situated on either side of said axis of symmetry each forming a parallelogram, the guidance of said member being obtained by means of a force exerted on said central mechanical structure parallel to said axis of symmetry.

2. The device as claimed in claim 1, wherein said beams comprise several rectilinear sections, the sections leading from the ends of said beams being parallel.

3. The device as claimed in claim 1, wherein said beams have non-constant cross sections.

4. The device as claimed in claim 3, wherein the cross section is at a minimum at the center of said beams.

5. The device as claimed in claim 3, wherein the cross section is at a maximum at the level of the attachment points of said beams.

6. The device as claimed in claim 1, wherein it is of monolithic structure.

7. The device as claimed in claim 1, wherein said mechanical structure is mobile.

8. The device as claimed in claim 1, wherein said central mechanical structure has, passing through it, a nut which is rigidly connected to it, said member being a screw collaborating with said nut.
